(19) United States
(12) Patent Application Publication
(10) Pub. No.: US 2022/0210211 A1
(43) Pub. Date: Jun. 30, 2022

(54) METHOD AND SYSTEM FOR VIDEO STORAGE, STREAMING, EDITTING AND SHARING OVER A COMMUNICATONS NETWORK

(71) Applicant: Depositions, Inc., Brookhaven, GA (US)

(72) Inventor: Russell Adler, Brookhaven, GA (US)

(21) Appl. No.: 17/136,507

(22) Filed: Dec. 29, 2020

(51) Int. Cl. H04L 29/06; G06K 9/00

(52) U.S. Cl. CPC H04L 65/601; G06K 9/00751; H04L 65/607; H04L 65/608

(57) ABSTRACT

A system and method for facilitating storage, streaming, editing and sharing of deposition videos over a communications network includes a database for storing user records and deposition videos, a first module on a first computing device for authenticating a first user, receiving and displaying a stream of deposition videos, and remotely editing the deposition videos and sharing the deposition videos, a second module on a second computing device for receiving and displaying a stream of the shared deposition videos, and a server for authenticating the first and second users streaming deposition videos and executing commands to edit deposition videos and sharing deposition videos.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The claimed subject matter relates to the field of electronic commerce and communications and, more specifically, the claimed subject matter relates to the field of video storage, streaming, editing and sharing using computing devices.

### BACKGROUND

The process of video sharing is a well-known phenomenon wherein one person shares an entire video or video clip with another or many other people. Typically, video sharing is performed over a communications network, such as the Internet. In current times, there are a wide variety of websites and mobile applications that offer video sharing services, such as YouTube. A video sharing website or mobile applications allows consumers to upload and share their videos or video clips with the public at large or to invited guests. Millions of web surfers use these video sharing websites and mobile applications to share videos for private or public viewing, both free and paid. Conventional video sharing websites and mobile applications, however, are not uniquely suited for all video sharing situations.

A deposition, or examination for discovery, involves the taking of sworn, out-of-court oral testimony of a witness that may be reduced to a written transcript for later use in court or for discovery purposes. Depositions are commonly used in litigation and are almost always conducted outside court by the lawyers themselves, with no judge present to supervise the examination. Depositions are a part of the discovery process in which litigants gather information in preparation for trial. With the advent of mobile devices and consumer electronics, video recordings of the deposition are often taken as well, which are referred to as “deposition videos.” A deposition video comprises a video of the deposition as it occurred in real time, including the audio of all the questions and answers that were spoken during the deposition.

One of the drawbacks associated with conventional video sharing websites and mobile applications involves the ability to store, stream, edit and share deposition videos. Conventional video sharing websites and mobile applications can be cumbersome to use, especially when presented in a mobile application format that provides a smaller interface area. Further, the ability to edit videos using conventional video sharing websites and mobile applications can be complicated and difficult to learn. Additionally, the functionality for sharing videos can be burdensome and involve a large number of clicks and entering of information, which can be annoying and time consuming for users.

Therefore, what is needed is a system and method for improving the problems with the prior art, and more particularly for a more expedient and efficient method and system for facilitating storage, streaming, editing and sharing deposition videos.

### BRIEF SUMMARY

In one embodiment, a system for facilitating storage, streaming, editing and sharing deposition videos over a communications network is disclosed. The system includes: a) a database communicatively coupled to the communications network, the database configured for storing a plurality of user records and a plurality of deposition videos; b) a first module executing on a first computing device communicably coupled to the communications network, the first module configured for: 1) transmitting a request over the communications network to authenticate a first user of the first computing device; 2) transmitting a request over the communications network to view a particular deposition video of the plurality of deposition videos; 3) receiving and displaying a stream of the particular deposition video over the communications network; 4) remotely editing the particular deposition video over the communications network; and 5) transmitting a request over the communications network to share the particular deposition video that was edited with a second computing device; c) a second module executing on the second computing device communicably coupled to the communications network, the second module configured for: 1) transmitting a request over the communications network to authenticate a second user of the second computing device; 2) receiving a link to the particular deposition video that was edited over the communications network; 3) transmitting a request over the communications network to view the particular deposition video that was edited; and 4) receiving and displaying a stream of the particular deposition video that was edited, over the communications network; and d) a server communicatively coupled with a communications network, the server configured for: 1) authenticating the first user against a first user record of the plurality of user records in the database; 2) streaming the particular deposition video over the communications network to the first computing device; 3) executing commands received over the communications network from the first computing device to edit the particular deposition video; 4) transmitting a link to the particular deposition video that was edited to the second computing device over the communications network; 5) authenticating the second user against a second user record of the plurality of user records in the database; 6) streaming the particular deposition video that was edited over the communications network to the second computing device.

Additional aspects of the claimed subject matter will be set forth in part in the description which follows, and in part will be obvious from the description, or may be learned by practice of the claimed subject matter. The aspects of the claimed subject matter will be realized and attained by means of the elements and combinations particularly pointed out in the appended claims. It is to be understood that both the foregoing general description and the following detailed description are exemplary and explanatory only and are not restrictive of the disclosed subject matter, as claimed.

### BRIEF DESCRIPTION OF THE SEVERAL VIEWS OF THE DRAWINGS

The accompanying drawings, which are incorporated in and constitute part of this specification, illustrate embodiments of the claimed subject matter and together with the description, serve to explain the principles of the claimed subject matter. The embodiments illustrated herein are presently preferred, it being understood, however, that the claimed subject matter is not limited to the precise arrangements and instrumentalities shown, wherein:

FIG. 1 is a block diagram illustrating the network architecture of a system for facilitating storage, streaming, editing and sharing of deposition videos over a communications network, in accordance with one embodiment.

FIG. 2 is a block diagram showing the data flow of the process for storage, streaming, editing and sharing of deposition videos over a communications network, according to one embodiment.

FIG. 3 is a flow chart depicting the general control flow of a process for facilitating storage, streaming, editing and sharing of deposition videos over a communications network, according to one embodiment.

FIG. 4 is a block diagram depicting a system including an example computing device and other computing devices.

FIG. 5A is a drawing depicting a first graphical user interface for facilitating storage, streaming, editing, and sharing of deposition videos over a communications network, according to one embodiment.

FIG. 5B is a drawing depicting a second graphical user interface for facilitating storage, streaming, editing, and sharing of deposition videos over a communications network, according to one embodiment.

FIG. 5C is a drawing depicting a third graphical user interface for facilitating storage, streaming, editing, and sharing of deposition videos over a communications network, according to one embodiment.

### DETAILED DESCRIPTION

The disclosed embodiments improve upon the problems with the prior art by providing a system that allows for quick and easy storage, streaming, editing and sharing of deposition videos. The disclosed embodiments provide a web site and/or mobile application that allows users to stream, edit and share deposition videos using a minimum of clicks, swipes, data entry and other interactions with a graphical user interface. Consequently, the disclosed embodiments reduce or eliminate the burden associated with said activities on a conventional system for storing, creating, editing, and sharing videos. This is advantageous for users, as it provides greater flexibility and time savings in video storage, streaming, editing and sharing activities. An additional benefit of the disclosed embodiments is the immediate sharing or dissemination of deposition video to a recipient's mobile device, which allows the recipient to experience the video immediately. The main benefit of the claimed subject matter is the improvement of the conventional video storage, streaming, editing, and sharing experience.

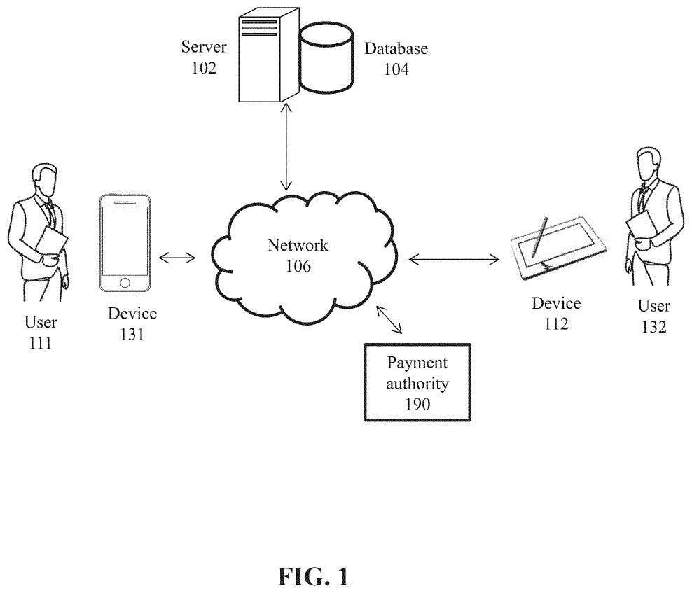

Referring now to the drawing figures in which like reference designators refer to like elements, there is shown in FIG. 1 an illustration of a block diagram showing the network architecture of a system 100 and method for facilitating storage, streaming, editing and sharing of deposition videos over a communications network in accordance with one embodiment. A prominent element of FIG. 1 is the server 102 associated with repository or database 104 and further communicatively coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Server 102 is a central controller or operator for functionality of the disclosed embodiments, namely, facilitating storage, streaming, editing and sharing deposition videos between users.

FIG. 1 includes mobile computing devices 131, 112, which may be smart phones, mobile phones, tablet computers, handheld computers, laptops, or the like. In another embodiment, mobile computing devices 131, 112, are workstations, desktop computers, servers, laptops, all-in-one computers, or the like. In another embodiment, mobile computing devices 131, 112, are AR or VR systems that may include display screens, headsets, heads up displays, helmet mounted display screens, tracking devices, tracking lighthouses or the like. Mobile computing device 112 corresponds to a user 132 of the video storage, streaming, editing and sharing services of the claimed embodiments. Mobile computing device 131 corresponds to a user 111 of the video storage, streaming, editing, and sharing services of the claimed embodiments, and may be a family member or acquaintance of user 132. Devices 131, 112 may be communicatively coupled with network 106 in a wired or wireless fashion. Augmented reality (AR) adds digital elements to a live view often by using a camera on a computing device. Virtual reality (VR) is a complete or near complete immersion experience that replaces the physical world. FIG. 1 also includes server 102, which may be smart phones, mobile phones, tablet computers, handheld computers, laptops, workstations, desktop computers, servers, laptops, all-in-one computers, or the like.

FIG. 1 further shows that server 102 includes a database or repository 104, which may be a relational database comprising a Structured Query Language (SQL) database stored in a SQL server. Devices 131, 112 may also each include their own database. The repository 104 serves data from a database, which is a repository for data used by server 102 and devices 131, 112 during the course of operation of the disclosed embodiments. Database 104 may be distributed over one or more nodes or locations that are connected via network 106.

The database 104 may include a user record for each user 111 or 132. A user record may include: contact/identifying information for the user (name, address, telephone number(s), email address, etc.), information pertaining to videos and clips associated with the user, contact/identifying information for friends of the user, electronic payment information for the user, information pertaining to the purchases made by the user, sales transaction data associated with the user, etc. A user record may also include a unique identifier for each user, a residential address for each user, the current location of each user (based on location-based services from the user's mobile computer) and a description of past videos and clips made, shared and viewed by each user. A user record may further include demographic data for each user, such as age, sex, income data, race, color, marital status, etc. A user record may also include contact information (email address, name, address, telephone number, etc.) or a unique identifier for one or more friends or acquaintances of the user.

Sales transaction data may include one or more product/service identifiers (such as SKUs), one or more product/service amounts, buyer contact/identifying information, and electronic payment information. In one embodiment, electronic payment information may comprise buyer contact/identifying information and any data garnered from a purchase card (i.e., purchase card data), as well as any authentication information that accompanies the purchase card. Purchase card data may comprise any data garnered from a purchase card and any authentication information that accompanies the purchase card. In one embodiment, electronic payment information may comprise user login data, such as a login name and password, or authentication information, which is used to access an account that is used to make a payment.

The database 104 may include a video record for each video. A video is defined as digital video and digital audio, whether located in one file or distributed among multiple files. Digital video is an electronic representation of moving visual images in the form of encoded digital data and digital audio is a representation of sound recorded in, or converted into, digital form. A video record may include a video file, an audio file, and any other related data, such as metadata. A video record may also include: a unique video identifier, contact/identifying information for the user associated with the video, a description of the video, a length of the video, an amount of space necessary to store the video, an author and/or editor of the video, data identifying with whom the video was shared, date and time stamp data for the video, and a data element that indicates whether the video has been viewed or opened by a recipient with which it was shared. In one embodiment, a video is a file or other data structure which may reside on the mobile device of a user, wherein, when opened or activated, displays a video.

FIG. 1 shows an embodiment wherein networked computing devices 131, 112 interact with server 102 and repository 104 over the network 106. It should be noted that although FIG. 1 shows only the networked computers 131, 112, and 102, the system of the disclosed embodiments supports any number of networked computing devices connected via network 106. Further, server 102, and units 131, 112, include program logic such as computer programs, mobile applications, executable files or computer instructions (including computer source code, scripting language code or interpreted language code that may be compiled to produce an executable file or that may be interpreted at run-time) that perform various functions of the disclosed embodiments.

Note that although server 102 is shown as a single and independent entity, in one embodiment, the functions of server 102 may be integrated with another entity, such as one of the devices 131, 112. Further, server 102 and its functionality, according to a preferred embodiment, can be realized in a centralized fashion in one computer system or in a distributed fashion wherein different elements are spread across several interconnected computer systems.

FIG. 1 also shows a payment authority 190, which acts to effectuate payments by users 111 or 132 for videos, access to server 102, or the like. In the course of a sales transaction, server 102 may interface with payment authority 190 to effectuate payment. In one embodiment, the payment authority 190 is a payment gateway, which is an e-commerce Application Service Provider (ASP) service that authorizes and processes payments from one party to another. The payment authority 190 may accept payment via the use of purchase cards, i.e., credit cards, charge cards, bank cards, gift cards, account cards, etc.

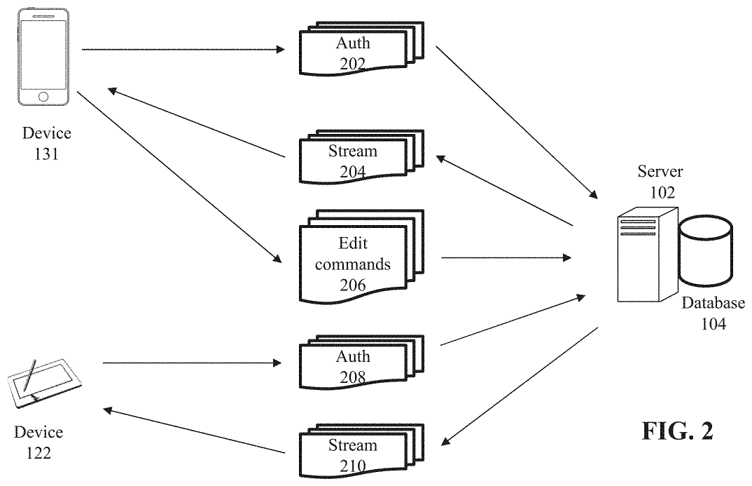

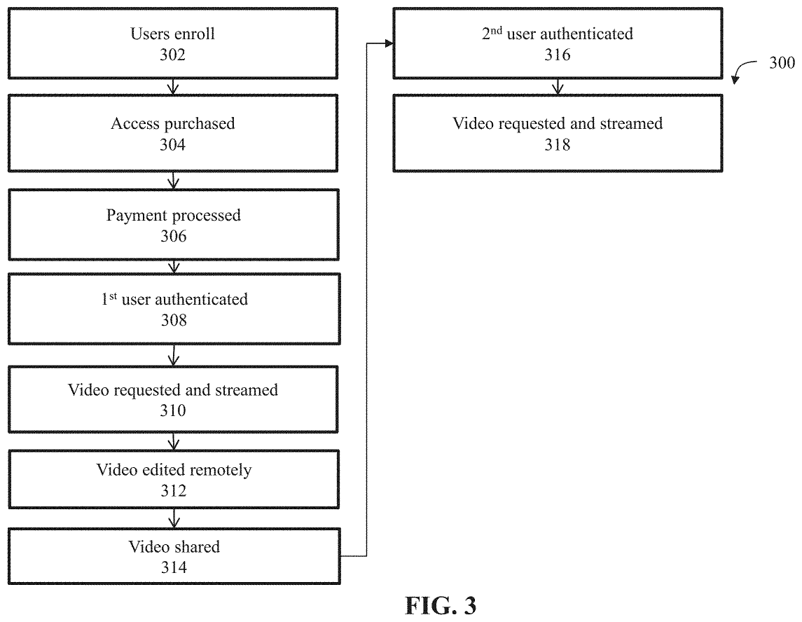

The process of storage, streaming, editing and sharing of deposition videos over a communications network will now be described with reference to FIGS. 2-3 below. FIGS. 2-3 depict the data flow and control flow of the process for facilitating storage, streaming, editing and sharing deposition videos over a communications network 106, according to one embodiment. The process of the disclosed embodiments begins with optional step 302 (see process or flowchart 300), wherein the users 111 and 132 may enroll or register with server 102. In the course of enrolling or registering, the users may enter data into their device by manually entering data into a mobile application via keypad, touchpad, or via voice. In the course of enrolling or registering, the users may enter any data that may be stored in a user record, as defined above. Also in the course of enrolling or registering, the server 102 may generate a user record for each registering user and store the user record in an attached database, such as database 104.

Subsequently, in optional step 304, the user 111 may purchase access to functionality of the server 102. The user 111 may purchase access utilizing a client module executing on his mobile computing device 131. The client module is configured for transmitting a request, such as an HTTP request, to server 102 to access server 102 and transmitting electronic payment data for said access, and a unique identifier (such as an email address, a name, a phone number, etc.) for the user 111, to the server 102.

In optional step 306, electronic payment information presented by the user 111 when purchasing access is transmitted by server 102 to payment authority 190 for processing. The payment authority 190 processes the electronic payment information and verifies whether payment has been effectuated. If so, the payment authority 190 may send a verification message to the server 102 thereby verifying that the payment has been effectuated.

In the next step 308, a first module executing on the first computing device 131 communicably coupled to the communications network 106 transmits a request 202 (which may be an HTTP request that includes a unique identifier for the first user) to server 102 over the communications network to authenticate the first user 111 of the first computing device 131. In response, the server 102 may receive the unique identifier for the first user, identify the first user record of the plurality of user records in the database that corresponds to the first user, and matches said unique identifier for the first user with a value in the first user record. If said match occurs, then server 102 authenticates the first user against a first user record of the plurality of user records in the database 104. If said match does not occur, then server 102 does not authenticate the first user.

In step 310, the first module executing on the first computing device 131 communicably coupled to the communications network 106 transmits a request to server 102 to view a particular deposition video of the plurality of deposition videos in the database 104 (which request may be an HTTP request that includes a unique identifier for the particular deposition video) over the communications network. In response, the server 102 may receive the unique identifier for the particular deposition video, access the particular deposition video in the database, and begins streaming the particular deposition video the first computing device 131 over the communications network 106. Subsequently, the first computing device 131 receives and displays the stream 204 of the particular deposition video over the communications network.

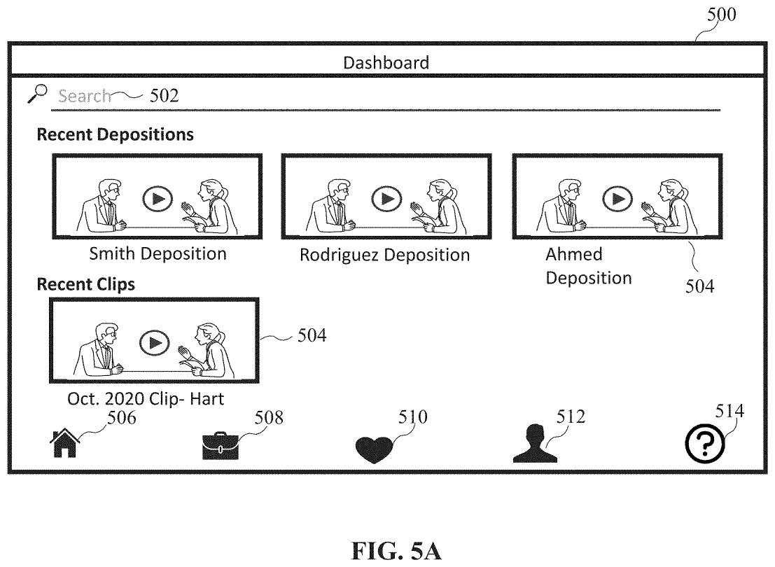

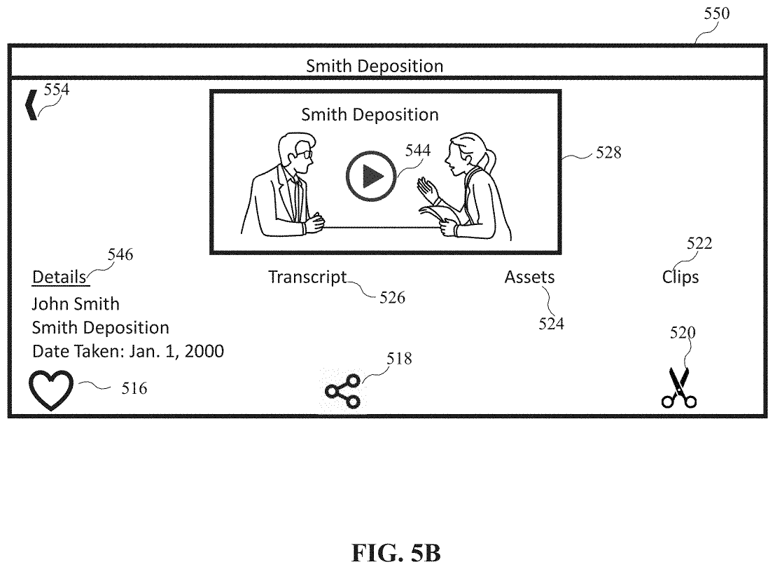

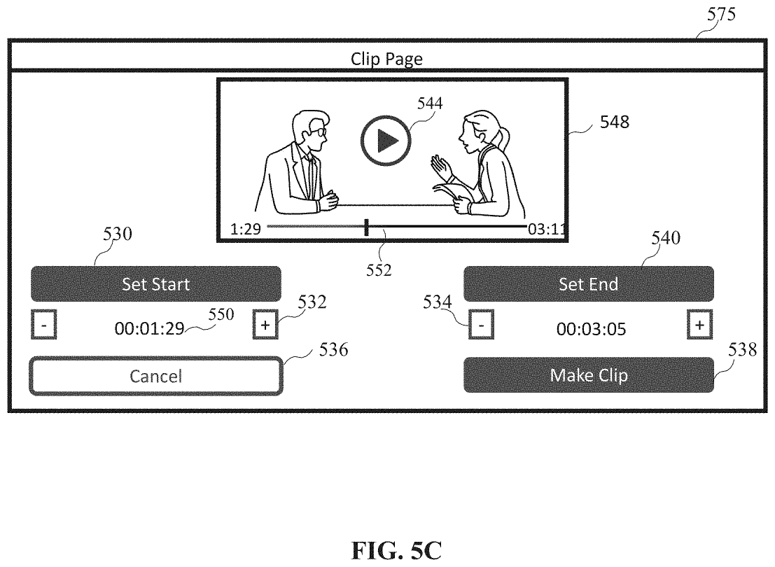

In step 312, the user 111 on the first computing device 131 remotely edits the particular deposition video over the communications network by issuing editing commands 206 over the communications network. In this step, the video remains on the server or database 104, and the system simply receives editing commands from the user 111 and executes the editing commands on the video on the server or database 104, i.e., the video is remotely edited such that it is not downloaded to the device 131 at the time of editing. This increases throughput, saves bandwidth, and provides a faster and more efficient video editing environment. See FIG. 5C for a more detailed explanation of the video editing process using a graphical user interface on the first module executing on the first computing device 131. The server executes the editing commands received from the first module executing on the first computing device 131.

The editing commands include a command to start a video clip at a certain time stamp on an existing video, a command to end a video clip at a certain timestamp on an existing video, a command to append one identified video clip to another identified video clip, a command to add additional seconds from an existing video to a video clip, a command to delete a predefined number of seconds from an existing video to a video clip, and a command to create a video clip based on the commands already given. The editing commands may further include a command to name the resulting video clip a certain title, a command to tag the resulting video clip with one or more informational tags, and the like. The commands may be transmitted via HTTP request.

In step 314, the first module executing on the first computing device 131 communicably coupled to the communications network 106 transmits a request to server 102 to share the particular deposition video that was edited with a second computing device 112 (which request may be an HTTP request that includes a unique identifier for the particular deposition video and a unique identifier for the second computing device 112 or second user 132) over the communications network. In response, the server 102 may receive the unique identifier for the particular deposition video that was edited and the unique identifier for the second computing device 112 or second user 132 and may transmit a link to the particular deposition video that was edited to the second computing device 112 over the communications network 106.

In the next step 316, a second module executing on the second computing device 112 communicably coupled to the communications network 106 transmits a request 208 (which request may be an HTTP request that includes a unique identifier for the second user) to server 102 over the communications network to authenticate the second user 132 of the second computing device 112. In response, the server 102 may receive the unique identifier for the second user, identify the second user record of the plurality of user records in the database that corresponds to the second user, and matches said unique identifier for the second user with a value in the second user record. If said match occurs, then server 102 authenticates the second user against a second user record of the plurality of user records in the database 104. If said match does not occur, then server 102 does not authenticate the second user.

In step 318, the second module executing on the second computing device 112 communicably coupled to the communications network 106 transmits a request to server 102 to view the particular deposition video in the link sent by server 102 (which request may be an HTTP request that includes a unique identifier for the particular deposition video) over the communications network. In response, the server 102 may receive the unique identifier for the particular deposition video, access the particular deposition video in the database, and begins streaming the particular deposition video the second computing device 112 over the communications network 106. Subsequently, the second computing device 112 receives and displays the stream 210 of the particular deposition video over the communications network.

FIG. 5A is a drawing depicting a first graphical user interface 500 for facilitating storage, streaming, editing, and sharing of deposition videos over a communications network, according to one embodiment. FIG. 5A shows a search bar 502, which can be utilized to search for any matters, depositions, or assets that have been stored on the server 102 and are associated with matters owned by or shared with user 111. The search can be conducted using any relevant detail about the deposition or asset including matter name, case number, file number, claim number, and client name. An asset may be any such document that is relevant to a matter including evidence documents, affidavits, deposition transcripts, and any other file deemed relevant to a user's matter(s).

FIG. 5A further includes thumbnails 504 of recently added depositions and clips. Each thumbnail will be identified either by the video name or a default name created using a matter name and the upload date. The videos represented by thumbnails 504 can be streamed either from the dashboard or in the page for a specific matter. The user can navigate to the matters tab using the matters button 508 on the navigation bar 542 to locate a matter and stream videos and clips associated therewith. The navigation bar 542 may additionally be used to navigate to a variety of other pages or tabs within the application. Specifically, the navigation bar 542 includes home button 506, represented by a residential home icon, can be used to navigate to the dashboard as described with reference to FIG. 5A; matters button 508, represented by a briefcase icon, takes the user to a page listing all open matters owned by the user and allows the user to interact with a specific matter on the deposition screen (see FIGS. 5B and 5C); favorites button 510, represented by a shaded-in heart, allows the user to see all depositions, clips, and assets that have been favorited by the user; accounts button 512, represented by a human bust icon, allows the user to access and edit the information stored in their user record; and a feedback button 514, represented by an icon including a question mark inside of a circle, allows the users to give feedback on their user experience.

FIG. 5B is a drawing depicting a second graphical user interface 550 for facilitating storage, streaming, editing, and sharing of deposition videos over a communications network, according to one embodiment. FIG. 5B shows thumbnail 528, which is a thumbnail of the main deposition in a selected matter. Thumbnail 528 is configured such that a user can press the play button 544 and stream the video file from the depositions screen. FIG. 5B additionally shows that the depositions screen provides the user with all of the relevant information regarding the deposition as well as various ways to interact therewith. Specifically, FIG. 5B shows 4 tabs which provide the user with additional data about the deposition. The details tab 546 provides the user with the name of the deponent, the chosen name for the deposition, and the date that the deposition was taken. Transcript tab 526 includes the full transcript of the deposition with time stamps included to facilitate the process of editing, or clipping, the depositions (further discussed with reference to FIG. 5C) by allowing a user to quickly identify the time marker associated with a specific statement or specific behavior. Assets tab 524 provides the user with any asset that is associated with a matter. As discussed above, an asset may be any document relevant a specific matter including evidentiary files, court documents, statements and the like. Clips tab 522 is the location where a user can create new clips (see FIG. 5C) and find and edit existing clips.

At the bottom of the depositions screen shown in FIG. 5B, the user is provided with icons that can be used to interact with the deposition file itself. The favorite icon 516 can be toggled on and off, with on indicating that the server should store the file for display on the favorites page, accessed by interacting with the favorited button 510 (see FIG. 5A). The deposition page of a video that has been favorited will display the favorite icon 516 colored in to indicate that the video has already been favorited. The share icon 518 may be used to share the selected deposition both with users and non-users of the application. Once pressed, the share icon generates a link that the user may copy and subsequently share by pasting it into any of an array of messaging applications. Clip icon 520 takes the user to a page wherein the user may edit the video and create clips thereof. The process of editing or clipping videos will be described in greater detail below, with reference to FIG. 5C.

FIG. 5C is a drawing depicting a third graphical user interface 575 for facilitating storage, streaming, editing, and sharing of deposition videos over a communications network, according to one embodiment. The clip page shown in FIG. 5C can be used by a user to stream and edit depositions and create clips therefrom. FIG. 5C shows deposition video 548, which is the main deposition in the matter selected by a user, paused mid-stream. The deposition can be streamed by pressing the play button 544, allowing the user to watch the video, identify important portions thereof, and subsequently create clips from the deposition.

The process of creating clips begins with the Set Start button 530 shown in FIG. 5C. A user may create a clip either while streaming the video within the Clip Page, or by entering specific start and end times on the video progress tracker 550. In order for a user to create a clip using the set start button, the user must stream the video using video player 548. Once the user has arrived at the point in the video where the new clip will begin, the user may press the Set Start button 530. Upon pressing the set start button, the current time as shown in the video progress bar 552 will be recorded as the clip start time as shown in video progress tracker 550, displayed beneath the start clip button. The user then continues streaming the deposition until the video progress bar reaches the position at which the user desires to end the clip that is being created. The user sets the end time in the same manner as the start time, but in this instance pressing the set end button 540. After a user has set both a start and end time for their desired clip, the process is completed by interacting with the make clip button 538. Created clips are stored on the server 102 and made accessible in various locations within the app. As discussed with reference to FIG. 5A, a user may find assets, including clips, by interacting with the matters button 508 and selecting the matter with which the clip is associated. Alternatively, a user may search for a clip using the title of the associated matter or the clip title in search bar 502. Recently recorded clips are displayed as thumbnails 504 in the recent clips section of the dashboard.

A user may also create a clip by manually entering a time or interacting with the plus and minus steppers, 532 and 534 respectively, until the desired start and end times are reached. Stepper 532 is a button with a plus sign design in the center that can be used to increase the desired start or end time of a clip being created by a user. Similarly, stepper 534 is a button including a minus sign design in the center, used to decrease the desired start or end time of a clip being created by a user. Once a user has either manually entered a start and end time for the clip being made, or used steppers 532 and 534 to do the same, the user may press the make clip button 538 to have the clip created and stored on server 102. If a user has mistakenly selected an incorrect deposition or matter, or no longer desires to create a clip, the user can simply press the cancel button 536 to be returned to the deposition's page, where the user can navigate back to the dashboard using back button 554 (see FIG. 5B).

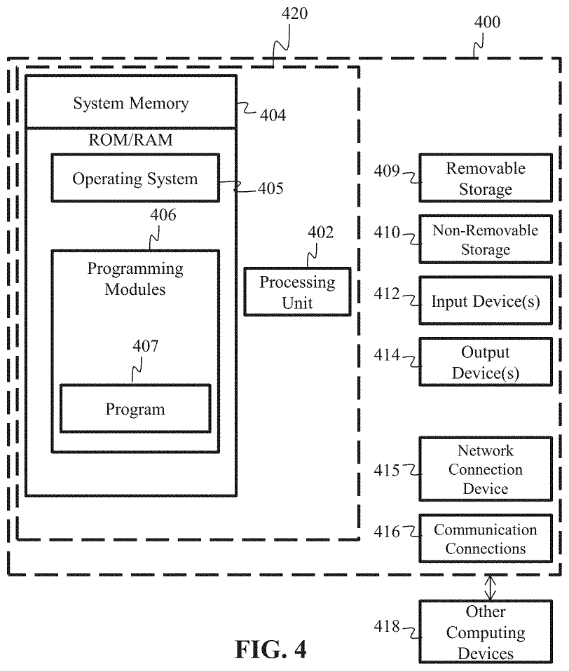

FIG. 4 is a block diagram of a system including an example computing device 400 and other computing devices. Consistent with the embodiments described herein, the aforementioned actions performed by 131, 112, 102 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for system 100 and process 300, as described above. Process 300 may operate in other environments and are not limited to computing device 400.

With reference to FIG. 4, a system consistent with an embodiment may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random-access memory (RAM)), non-volatile (e.g. read-only memory (ROM)), flash memory, or any combination or memory. System memory 404 may include operating system 405, and one or more programming modules 406. Operating system 405, for example, may be suitable for controlling computing device 400's operation. In one embodiment, programming modules 406 may include, for example, a program module 407 for executing the actions of 131, 112, 102. Furthermore, embodiments may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. Computing device 400 may also include a vibration device capable of initiating a vibration in the device on command, such as a mechanical vibrator or a vibrating alert motor. The aforementioned devices are only examples, and other devices may be added or substituted.

Computing device 400 may also contain a network connection device 415 that may allow device 400 to communicate with other computing devices 418, such as over a network in a distributed computing environment, for example, an intranet or the Internet. Device 415 may be a wired or wireless network interface controller, a network interface card, a network interface device, a network adapter or a LAN adapter. Device 415 allows for a communication connection 416 for communicating with other computing devices 418. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 (e.g. program module 407) may perform processes including, for example, one or more of the stages of the process 300 as described above. The aforementioned processes are examples, and processing unit 402 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, any of the steps or processes described herein may be performed automatically using no additional user input.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for facilitating storage, streaming, editing, and sharing of videos over a communications network, the system comprising:
a) a database communicatively coupled to the communications network, the database configured for storing a plurality of user records and a plurality of deposition videos;
b) a first module executing on a first computing device communicably coupled to the communications network, the first module configured for:
1) transmitting a request over the communications network to authenticate a first user of the first computing device;
2) transmitting a request over the communications network to view a particular deposition video of the plurality of deposition videos;
3) receiving and displaying a stream of the particular deposition video over the communications network;
4) remotely editing the particular deposition video over the communications network; and
5) transmitting a request over the communications network to share the particular deposition video that was edited with a second computing device;
c) a second module executing on the second computing device communicably coupled to the communications network, the second module configured for:
1) transmitting a request over the communications network to authenticate a second user of the second computing device;
2) receiving a link to the particular deposition video that was edited over the communications network;
3) transmitting a request over the communications network to view the particular deposition video that was edited; and
4) receiving and displaying a stream of the particular deposition video that was edited, over the communications network; and
d) a server communicatively coupled with a communications network, the server configured for:
1) authenticating the first user against a first user record of the plurality of user records in the database;
2) streaming the particular deposition video over the communications network to the first computing device;
3) executing commands received over the communications network from the first computing device to edit the particular deposition video;
4) transmitting a link to the particular deposition video that was edited to the second computing device over the communications network;
5) authenticating the second user against a second user record of the plurality of user records in the database;
6) streaming the particular deposition video that was edited over the communications network to the second computing device.

2. The system of claim 1, wherein the step of transmitting a request over the communications network to authenticate the first user further comprises transmitting an HTTP request including a unique identifier for the first user.

3. The system of claim 2, wherein the step of transmitting a request over the communications network to view a particular deposition video of the plurality of deposition videos further comprises transmitting an HTTP request including a unique identifier for the particular deposition video.

4. The system of claim 3, wherein the step of remotely editing the particular deposition video over the communications network further comprises transmitting multiple editing commands over the communications network to edit the particular deposition video.

5. The system of claim 4, wherein the step of transmitting a request over the communications network to share the particular deposition video that was edited further comprises transmitting an HTTP request including a unique identifier for the particular deposition video that was edited and a unique identifier for the second computing device.

6. The system of claim 5, wherein the step of transmitting a request over the communications network to authenticate the second user further comprises transmitting an HTTP request including a unique identifier for the second user.

7. The system of claim 6, wherein the step of transmitting a request over the communications network to view the particular deposition video that was edited further comprises transmitting an HTTP request including a unique identifier for the particular deposition video that was edited.

8. The system of claim 7, wherein the step of authenticating the first user against a first user record further comprises receiving the unique identifier for the first user over the communications network, identifying the first user record of the plurality of user records that corresponds to the first user, and matching said unique identifier for the first user with a value in the first user record.

9. The system of claim 8, wherein the step of authenticating the second user against a second user record further comprises receiving the unique identifier for the second user over the communications network, identifying the second user record of the plurality of user records that corresponds to the second user, and matching said unique identifier for the second user with a value in the second user record.

10. The system of claim 9, wherein each user record of the plurality of user records in the database corresponds to a particular user, and wherein each user record includes a value that corresponds to a unique identifier for the particular user.

11. A system for facilitating storage, streaming, editing, and sharing of videos over a communications network, the system comprising:
a) a database communicatively coupled to the communications network, the database configured for storing a plurality of user records and a plurality of deposition videos, wherein each deposition video of the plurality of deposition videos includes a timestamped text transcription;
b) a first module executing on a first computing device communicably coupled to the communications network, the first module configured for:
1) transmitting a request over the communications network to authenticate a first user of the first computing device;
2) transmitting a request over the communications network to view a particular deposition video of the plurality of deposition videos;
3) receiving and displaying a stream of the particular deposition video over the communications network;
4) remotely editing the particular deposition video over the communications network; and
5) transmitting a request over the communications network to share the particular deposition video that was edited with a second computing device;
c) a second module executing on the second computing device communicably coupled to the communications network, the second module configured for:
1) transmitting a request over the communications network to authenticate a second user of the second computing device;
2) receiving a link to the particular deposition video that was edited over the communications network;
3) transmitting a request over the communications network to view the particular deposition video that was edited; and
4) receiving and displaying a stream of the particular deposition video that was edited, over the communications network; and
d) a server communicatively coupled with a communications network, the server configured for:
1) authenticating the first user against a first user record of the plurality of user records in the database;
2) streaming the particular deposition video over the communications network to the first computing device;
3) executing commands received over the communications network from the first computing device to edit the particular deposition video;
4) transmitting a link to the particular deposition video that was edited to the second computing device over the communications network;
5) authenticating the second user against a second user record of the plurality of user records in the database;
6) streaming the particular deposition video that was edited over the communications network to the second computing device.

12. The system of claim 11, wherein the step of transmitting a request over the communications network to authenticate the first user further comprises transmitting an HTTP request including a unique identifier for the first user.

13. The system of claim 12, wherein the step of transmitting a request over the communications network to view a particular deposition video of the plurality of deposition videos further comprises transmitting an HTTP request including a unique identifier for the particular deposition video.

14. The system of claim 13, wherein the step of remotely editing the particular deposition video over the communications network further comprises transmitting multiple editing commands over the communications network to edit the particular deposition video.

15. The system of claim 14, wherein the step of transmitting a request over the communications network to share the particular deposition video that was edited further comprises transmitting an HTTP request including a unique identifier for the particular deposition video that was edited and a unique identifier for the second computing device.

16. The system of claim 15, wherein the step of transmitting a request over the communications network to authenticate the second user further comprises transmitting an HTTP request including a unique identifier for the second user.

17. The system of claim 16, wherein the step of transmitting a request over the communications network to view the particular deposition video that was edited further comprises transmitting an HTTP request including a unique identifier for the particular deposition video that was edited.

18. The system of claim 17, wherein the step of authenticating the first user against a first user record further comprises receiving the unique identifier for the first user over the communications network, identifying the first user record of the plurality of user records that corresponds to the first user, and matching said unique identifier for the first user with a value in the first user record.

19. The system of claim 18, wherein the step of authenticating the second user against a second user record further comprises receiving the unique identifier for the second user over the communications network, identifying the second user record of the plurality of user records that corresponds to the second user, and matching said unique identifier for the second user with a value in the second user record.

20. The system of claim 19, wherein each user record of the plurality of user records in the database corresponds to a particular user, and wherein each user record includes a value that corresponds to a unique identifier for the particular user.
